(19) United States
(12) Patent Application Publication
(10) Pub. No.: US 2020/0162281 A1
(43) Pub. Date: May 21, 2020

(54) INFORMATION OUTPUT METHOD, INFORMATION OUTPUT DEVICE, AND NON-TRANSITORY COMPUTER-READABLE RECORDING MEDIUM RECORDING INFORMATION OUTPUT PROGRAM

(71) Applicant: Panasonic Intellectual Property Management Co., Ltd., Osaka (JP)

(72) Inventors: Chieko SASAKI, Osaka (JP); Takayuki NISHIKAWA, Osaka (JP)

(21) Appl. No.: 16/675,548

(22) Filed: Nov. 6, 2019

(30) Foreign Application Priority Data
Nov. 16, 2018 (JP) 2018-215188

(51) Int. Cl. H04L 12/28

(52) U.S. Cl. CPC H04L 12/2829; H04L 2012/285; H04L 12/282; H04L 12/2814

(57) ABSTRACT

An information output method of an information output device that outputs information prompting implementation of a function installed in an apparatus acquires operation history information indicating a history of an operation state of the apparatus, estimates, by using the operation history information, an unused time period in which the apparatus is not used, determines a function to be implemented in the unused time period in future, based on the unused time period and a time period required from start to end of the function, and outputs information prompting implementation of the determined function in the unused time period.

### FIELD OF THE INVENTION

The present disclosure relates to an information output method for outputting information prompting the implementation of a function installed in an apparatus, an information output device, and a non-transitory computer-readable recording medium recording an information output program.

### BACKGROUND ART

As progressing in advancement, home appliances are equipped with various functions, such as a cleaning function of home appliances to clean their own components, a failure inspection function of home appliances to check their own failure, or a special function of home appliances to perform complicated device control, other than main functions of home appliances, such as a cooling function of an air conditioner or a washing function of a washing machine. With the advancement of home appliances, a variety of detailed functions that vary depending on applications are prepared for the home appliances, and it is necessary for the user himself or herself to select a function according to an application.

In home appliances, when a maintenance function for supporting maintenance in a case where the user does not perform maintenance of the home appliances, a function according to an application, such as a type of laundry, or the like is not used at all or not used at an appropriate timing, there is a possibility that the service life of home appliances is shortened or detection of the failure is delayed. In order to reduce the possibility of failure, home appliance manufacturers recommend the user to perform maintenance himself or herself or use various functions incorporated in the home appliances.

However, special functions, such as a maintenance function, take a long time to be implemented, and there is an inconvenience that the home appliances cannot be used during the implementation of a special function.

For example, Japanese Patent No. 6331668 discloses a technique in which, when a sign of a defect event requiring maintenance work for a printer is detected, a scheduled execution time of the maintenance work corresponding to the defect event indicated by the sign is set to be within an idle time which does not fall within a scheduled execution time of any processing shown in processing schedule information.

When the technique described in U.S. Pat. No. 6,331,668 described above is applied to home appliances, there is possibility that implementation of maintenance work is suggested while the user is operating a home appliance if the user does not reserve all operations of the home appliance in advance at the time of determining the schedule of the maintenance work. In this case, in order to continue the current operation of the home appliance, the user stops the implementation of the maintenance work with high probability, and the maintenance work is not implemented.

### SUMMARY OF THE INVENTION

The present disclosure has been made to solve the above-described problems, and an object of the present disclosure is to provide an information output method, an information output device, and a non-transitory computer-readable recording medium recording an information output program that can prompt the implementation of a function installed in an apparatus in an unused time period, in which the apparatus is not used, without requiring the user to input a usage schedule of the apparatus, and increase the frequency of the implementation of the function installed in the apparatus.

An information output method according to an aspect of the present disclosure is an information output method of an information output device that outputs information prompting implementation of a function installed in an apparatus, the information output method including acquiring operation history information indicating a history of an operation state of the apparatus, estimating, by using the operation history information, an unused time period in which the apparatus is not used, determining a function to be implemented in the unused time period in future, based on the unused time period and a time period required from start to end of the function, and outputting information prompting implementation of the determined function in the unused time period.

### BRIEF DESCRIPTION OF THE DRAWINGS

FIG. 1 is a diagram showing an example of a configuration of a home appliance control system according to a first embodiment of the present disclosure;

FIG. 2 is a block diagram showing an example of a configuration of a server and a washing machine shown in FIG. 1;

FIG. 3 is a diagram showing an example of operation history information of the washing machine, the operation history information stored in an operation history storage unit shown in FIG. 2;

FIG. 4 is a diagram showing an example of function information of the washing machine, the function information stored in a function information storage unit shown in FIG. 2;

FIG. 5 is a diagram showing an example of information output by an output unit shown in FIG. 2;

FIG. 6 is a first flowchart showing an example of information output processing by the washing machine according to the first embodiment;

FIG. 7 is a second flowchart showing an example of the information output processing by the washing machine according to the first embodiment;

FIG. 8 is a diagram showing an example of an operation state table in the first embodiment;

FIG. 9 is a diagram showing an example of a table in which the number of times the user stops a function automatically implemented immediately after the end of operation and the number of times the function is implemented are associated in the first embodiment;

FIG. 10 is a diagram showing an example of an estimated idle time period in the first embodiment;

FIG. 11 is a diagram showing an example of a configuration of a home appliance control system according to a second embodiment of the present disclosure;

FIG. 12 is a block diagram showing an example of a configuration of a server and an air conditioner shown in FIG. 11;

FIG. 13 is a diagram showing an example of operation history information of the air conditioner, the operation history information being stored in an operation history storage unit shown in FIG. 12;

FIG. 14 is a diagram showing an example of function information of the air conditioner, the function information being stored in a function information storage unit shown in FIG. 12;

FIG. 15 is a diagram showing an example of information output by an output unit shown in FIG. 12;

FIG. 16 is a diagram showing an example of a washing machine and an air conditioner installed in a home environment in a third embodiment of the present disclosure;

FIG. 17 is a block diagram showing an example of a configuration of the washing machine shown in FIG. 16;

FIG. 18 is a block diagram showing an example of a configuration of the air conditioner shown in FIG. 16;

FIG. 19 is a diagram showing an example of a configuration of a home appliance control system according to a fourth embodiment of the present disclosure;

FIG. 20 is a block diagram showing an example of a configuration of a server and a washing machine shown in FIG. 19;

FIG. 21 is a diagram showing an example of an operation history of the washing machine, the operation history being stored in an operation history storage unit shown in FIG. 20;

FIG. 22 is a diagram showing an example of a configuration of a home appliance control system according to a fifth embodiment of the present disclosure; and

FIG. 23 is a block diagram showing an example of a configuration of a home appliance controller and a washing machine shown in FIG. 22.

### DESCRIPTION OF EMBODIMENTS

### Finding Underlying the Present Disclosure

The method of U.S. Pat. No. 6,331,668 is based on the premise that a plurality of persons reserve in advance and use an appliance, so an idle time is clear and it is easy to set the scheduled implementation time for the maintenance work. Further, U.S. Pat. No. 6,331,668 is based on the premise that maintenance work needs to be carried out.

Home appliances may have a function for reserving in advance and using the home appliances systematically, however, a user does not reserve and use all home appliances throughout the day, and the user uses home appliances according to daily living conditions and environmental conditions. Since home appliances are used in the situations as described above, an idle time is not clear, and the schedule management for the maintenance work is not easy.

Further, even in a case where home appliances suggest implementation of a maintenance function, the maintenance function is not always implemented. Since implementation of the maintenance function is determined by the intension of the user, there is a possibility that the maintenance function is not implemented. In consideration of the possibility that the maintenance function is not implemented, there is also a home appliance that automatically implements a maintenance function after the end of operation of the home appliance. For example, an air conditioner is equipped with a maintenance function of cleaning a filter automatically after the end of cooling. However, in a case the user feels troublesome about an operation sound when a maintenance function is performed, or the user does not feel it necessity to implement the maintenance function, the user sometimes manually ends the maintenance function implemented automatically. In order for a home appliance to be used for a long time, a manufacturer desires to increase the frequency at which the maintenance function is implemented by suggesting, at an appropriate timing, implementation of the maintenance function to the user who rarely implements a maintenance function.

In order to achieve the above object, an information output method according to an aspect of the present disclosure is an information output method of an information output device that outputs information prompting implementation of a function installed in an apparatus, the information output method including acquiring operation history information indicating a history of an operation state of the apparatus, estimating, by using the operation history information, an unused time period in which the apparatus is not used, determining a function to be implemented in the unused time period in future based on the unused time period and a time period required from start to end of the function, and outputting information prompting implementation of the determined function in the unused time period.

According to this configuration, an unused time period in which the apparatus is not used is estimated using the operation history information indicating a history of an operation state of the apparatus, a function to be implemented in the unused time period in the future is determined based on the unused time period and a time period required from the start to the end of the function, and information prompting the implementation of the determined function in the unused time period is output. Accordingly, it is possible to prompt the implementation of a function installed in the apparatus in an unused time period in which the apparatus is not used, without requiring the user to input a usage schedule of the apparatus, and to increase the frequency of the implementation of the function installed in the apparatus.

Further, the information output method described above may further count the number of times the user has stopped a function that is implemented immediately after the end of operation of the apparatus, and exclude a predetermined time period immediately after the end of operation of the apparatus from the unused time period in a case where the number of times is larger than or equal to a threshold value in estimation of the unused time period.

According to this configuration, in a case where the user tends to stop a function implemented immediately after the end of operation of the apparatus, a predetermined time period immediately after the end of operation of the apparatus is excluded from the unused time period in which the apparatus is not used. In this manner, it is possible to prevent the implementation of the function from being prompted immediately after the end of operation of the apparatus, and to prompt the implementation of the function in the unused time period in which there is high possibility that the user implements the function.

Further, in the above information output method, input by the user as to whether or not to implement the determined function in the unused time period may further be received.

According to this configuration, since input by the user as to whether or not to implement the determined function in the unused time period is received, the apparatus can be reserved for implementation of the determined function in the unused time period.

Further, in the above information output method, the determined function may further be implemented in the unused time period in a case where input by the user showing implementation of the determined function in the unused time period is received.

According to this configuration, the determined function is implemented in the unused time period in a case where input by the user showing implementation of the determined function in the unused time period is received, so it can be ensured that the function is implemented in the time period desired by the user.

Further, in the above information output method, the user may further be notified of the fact that implementation of the determined function is implementation based on the output information within a predetermined time period before a time to start implementation of the determined function or within a predetermined time after a time to start implementation of the determined function.

According to this configuration, the user is notified of the fact that implementation of the determined function is implementation based on the output information within a predetermined time period before a time to start implementation of the determined function or within a predetermined time after a time to start implementation of the determined function. Accordingly, the user can know why the apparatus starts operation when the apparatus suddenly starts operation.

Further, in the above information output method, the user may further be notified of information prompting implementation of preliminary work performed before implementation of the determined function a predetermined time period before a time to start the implementation of the determined function.

According to this configuration, when preliminary work is required before the determined function is implemented, the user can be prompted to perform the preliminary work, and the determined function can be reliably implemented.

Further, in the above information output method, in the determination of the function, an implementation interval from implementation of the function to next implementation of the function may be acquired, a function that is capable of being implemented in the unused time period may be extracted, and, in a case where a period from previous implementation of the extracted function to present is longer than the implementation interval, the extracted function may be determined to be a function to be implemented in the unused time period.

According to this configuration, a function installed in an apparatus has an optimum implementation interval, a function to be implemented in the unused time period can be determined in consideration of the optimum implementation interval, and implementation of a function can be prompted at an optimum timing.

Further, in the above information output method, the function may include a function of performing maintenance of the apparatus.

According to this configuration, it is possible to prompt the implementation of the function for performing maintenance of the apparatus in the unused time period in which the apparatus is not used, without having the user input a usage schedule of the apparatus, and to increase the frequency of implementation of the function of performing maintenance of the apparatus. By increasing the frequency of the implementation of the function of performing maintenance of the apparatus, the lifetime of the apparatus can be extended and the apparatus can be prevented from breakdown.

Further, in the above information output method, in the estimation of the unused time period, the unused time period at or after the current time may be estimated based on an operation pattern of the apparatus in a predetermined period in the past.

According to this configuration, the unused time period at or after the current time is estimated based on an operation pattern of the apparatus in a predetermined period in the past. Accordingly, for example, by estimating the unused time period at or after the current time using the operation history information of the same day of the week as today in the past, the unused time period at or after the current time can be estimated based on an operation state of the apparatus according to the day of the week, and the unused time period can be estimated more accurately.

Further, in the above information output method, the unused time period may include a plurality of unused time periods, and, in the determination of the function, a function to be implemented in an unused time period closest to the current time among the plurality of unused time periods may be determined.

According to this configuration, even in a case where a plurality of unused time periods are estimated, it is possible to determine a function to be implemented in an unused time period closest to the current time among the plurality of unused time periods.

Further, in the above information output method, the operation history information may include an operation start time and an operation end time.

According to this configuration, the operation history information includes an operation start time and an operation end time. Therefore, a period in which the apparatus is used in the past can be identified based on the operation start time and the operation end time, and the unused time period can be estimated based on a period in which the identified apparatus is used.

Further, in the above information output method, the operation history information may include weather information at a time point at which the apparatus is operated together with the operation state, and, further, weather information at or after a current time may be acquired, and, in acquisition of the operation history information, the operation history information including weather information that is the same as weather information at or after the acquired current time may be acquired.

According to this configuration, operation history information including the same weather information as the weather information at or after the current time is acquired. Accordingly, it is possible to estimate a more accurate unused time period in consideration of the weather information.

An information output device according to another aspect of the present disclosure is an information output device that outputs information prompting implementation of a function installed in an apparatus. The information output device includes an acquisition unit configured to acquire operation history information indicating a history of an operation state of the apparatus, an estimation unit configured to estimate, by using the operation history information, an unused time period in which the apparatus is not used, a determination unit configured to determine a function to be implemented in the unused time period in future, based on the unused time period and a time period required from start to end of the function, and an output unit configured to output information prompting implementation of the determined function in the unused time period.

According to this configuration, an unused time period in which the apparatus is not used is estimated using the operation history information indicating a history of an operation state of the apparatus, a function to be implemented in the unused time period in the future is determined based on the unused time period and a time period required from the start to the end of the function, and information prompting the implementation of the determined function in the unused time period is output. Accordingly, it is possible to prompt the implementation of a function installed in the apparatus in an unused time period in which the apparatus is not used, without requiring the user to input a usage schedule of the apparatus, and to increase the frequency of the implementation of the function installed in the apparatus.

A non-transitory computer-readable recording medium recording an information output program according to another aspect of the present disclosure is a non-transitory computer-readable recording medium recording an information output program that outputs information prompting implementation of a function installed in an apparatus that causes a computer to acquire operation history information indicating a history of an operation state of the apparatus, estimate, by using the operation history information, an unused time period in which the apparatus is not used, determine a function to be implemented in the unused time period in future based on the unused time period and a time period required from start to end of the function, and output information prompting implementation of the determined function in the unused time period.

According to this configuration, an unused time period in which the apparatus is not used is estimated using the operation history information indicating a history of an operation state of the apparatus, a function to be implemented in the unused time period in the future is determined based on the unused time period and a time period required from the start to the end of the function, and information prompting the implementation of the determined function in the unused time period is output. Accordingly, it is possible to prompt the implementation of a function installed in the apparatus in an unused time period in which the apparatus is not used, without requiring the user to input a usage schedule of the apparatus, and to increase the frequency of the implementation of the function installed in the apparatus.

Hereinafter, embodiments of the present disclosure will be described with reference to the drawings.

Note that the embodiments described below are all for showing one specific example of the present disclosure. Numerical values, shapes, constituents, steps, order of steps, and the like described in the embodiments below are merely examples, and are not intended to limit the present disclosure. Further, among the components in the embodiments below, a component not described in an independent claim indicating the highest concept is described as an optional constituent. Further, in all the embodiments, each of contents can be combined.

### First Embodiment

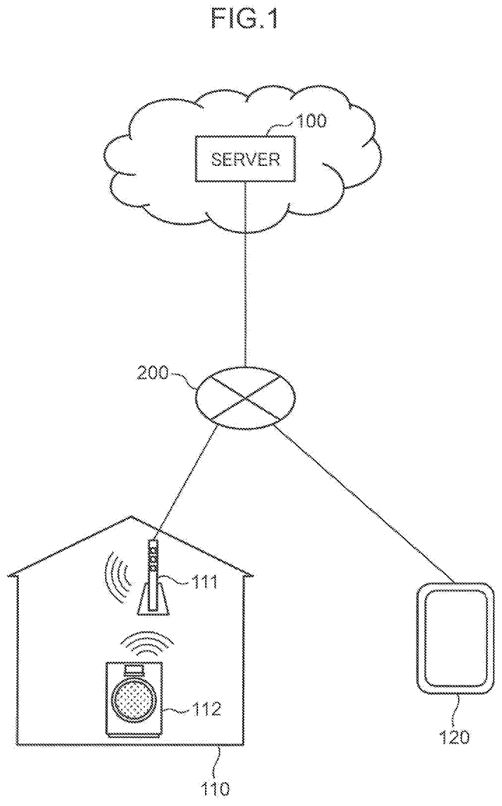

FIG. 1 is a diagram showing an example of a configuration of a home appliance control system according to a first embodiment of the present disclosure. The home appliance control system shown in FIG. 1 includes a server 100, a terminal 120, a broadband router 111, and a washing machine 112.

The broadband router 111 and the washing machine 112 are installed in a home environment 110.

Here, the home environment 110 is, for example, an area of a house of the user in which a local area network, such as an in-home network, can be used. However, the present disclosure is not particularly limited to this example, and the home environment 110 may be an area within a facility or enterprise building, and the like where a local area network, such as an in-facility or in-enterprise network, can be used.

The server 100 is communicably connected to the terminal 120 and the broadband router 111 via a network 200. The broadband router 111 is communicably connected to the washing machine 112 in the same home environment 110 by radio.

Although one home environment 110 is illustrated in FIG. 1, a plurality of other home environments may exist on the same network, and the server 100 may be connected to a home appliance installed in each of a plurality of home environments. Further, the number of the terminals 120 is not particularly limited to the example shown in FIG. 1, and the server 100 may be connected to a plurality of terminals. Further, for example, although the Internet is used as the network 200, the present disclosure is not particularly limited to this example, and a wide area network, such as a mobile telephone communication network, may be used.

The terminal 120 is, for example, a personal computer, a tablet computer, a smartphone, or the like, and is used to control the washing machine 112 from inside or outside the house other than an input unit of the main body of the washing machine 112, and the like.

In the home environment 110, the broadband router 111 and the washing machine 112 are installed. The washing machine 112 establishes a Wi-Fi (registered trademark) connection with the broadband router 111 and is communicably connected to the network 200 via the broadband router 111.

Note that, in the first embodiment, input to the washing machine 112 is performed from an input unit provided on the main body. However, there are also home appliances provided with a remote controller, such as an air conditioner. The present disclosure is not particularly limited to these examples, and the input to the washing machine 112 may be performed from the terminal 120 including an infrared transmission unit, an input button provided on an apparatus main body, an infrared transmitter that generates an optional remote operation request, or the like.

Further, since the washing machine 112 in the first embodiment has a communication function, the terminal 120 having a communication function may transmit a remote operation request to the washing machine 112 via the network 200. In this case, the terminal 120 that makes a remote operation request may be an input device of the washing machine 112.

Further, although FIG. 1 shows one washing machine 112 as an example of home appliances in the home environment 110, this is an example. The home appliance control system may include a plurality of home appliances and a plurality of types of home appliances. As an apparatus to which the first embodiment is applied, various apparatuses, such as a home appliance or a business-use appliance, can be used, and an air conditioner, an air cleaner, a dehumidifier, or the like may be used, for example.

Further, in FIG. 1, the broadband router 111 and the washing machine 112 directly establish a Wi-Fi connection, and the broadband router 111 is connected to the network 200. However, the present disclosure is not particularly limited to this example, and a home energy management system (HEMS) controller that brings together control of home appliances in the home environment 110 and a network connection may be used. Further, in a case where a home appliance does not have a wireless communication function, the configuration may be such that the home appliance is connected by wire to a relay device having a network function, and the relay device is connected to the broadband router 111. Further, in FIG. 1, although the broadband router 111 is present, in a case where a home appliance is provided with a function to connect to the Internet alone, the home appliance may be directly connected to the network 200 without using the broadband router 111.

The home appliance control system of FIG. 1 constitutes a server client model in which the server 100 is a server and the washing machine 112 is a client. The server-client model is a form in which a client sends a request to a server, the server processes the request (returns a response, depending on a purpose of the system), and the server and the client cooperate via a network. The home appliance control system according to the first embodiment performs cooperation processing, such as that the washing machine 112 transmits operation information or identification information unique to a home appliance to the server 100, and the server 100 notifies operation information to the terminal 120 of the user registered so as to cooperate with the washing machine 112.

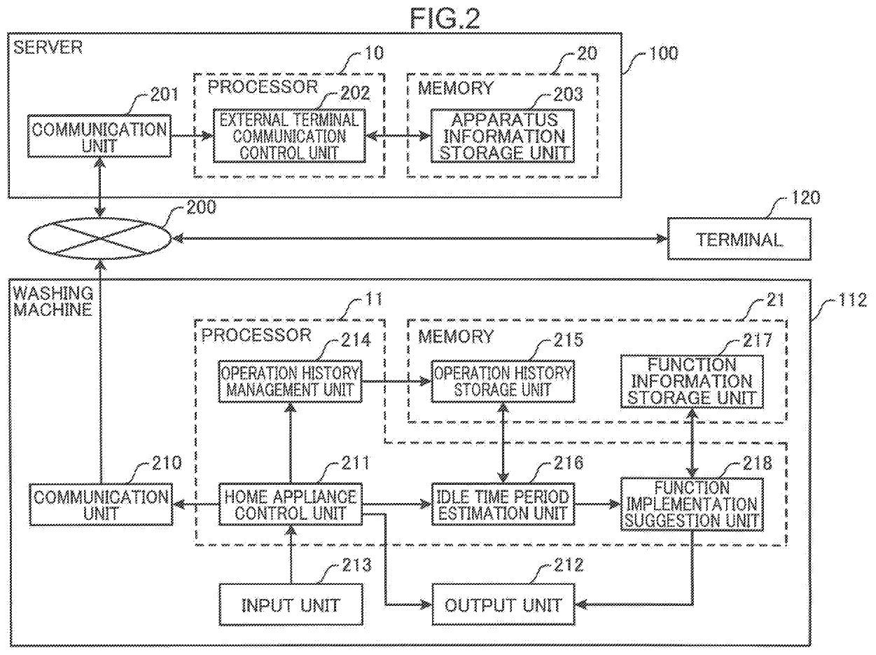

FIG. 2 is a block diagram showing an example of a configuration of the server and the washing machine shown in FIG. 1. The cooperation processing of the server client model of the home appliance control system in the first embodiment will be described with reference to FIG. 2. Note that in FIG. 2, in order to simplify the illustration and description, only the configurations of the server 100 and the washing machine 112 are illustrated, illustration of the broadband router 111 is omitted, and the washing machine 112 is connected to the server 100.

The server 100 includes a processor 10, a memory 20, and a communication unit 201 in order to obtain a server function. The processor 10 includes an external terminal communication control unit 202. The memory 20 includes an apparatus information storage unit 203.

The washing machine 112 includes a processor 11, a memory 21, a communication unit 210, an output unit 212, and an input unit 213 in order to obtain a client function. The processor 11 includes a home appliance control unit 211, an operation history management unit 214, an idle time period estimation unit 216, and a function implementation suggestion unit 218. The memory 21 includes an operation history storage unit 215 and a function information storage unit 217.

The input unit 213 is, for example, a touch panel, and receives an input operation by the user. The input unit 213 receives, for example, input of power on/off, a selection of a course of any of “washing”, “washing-drying”, and “drying”, and input of reservation time.

The home appliance control unit 211 controls the washing machine 112 corresponding to input operation. The home appliance control unit 211 implements a main function of performing the original operation of the washing machine 112, such as a washing function and a drying function, and also performs a subfunction of performing maintenance of the washing machine 112, such as a mold suppression function and a tank cleaning function, and the like When starting operation in a predetermined course, the home appliance control unit 211 notifies the operation history management unit 214 of operation information indicating that operation in the predetermined course has started. Further, when finishing operation in a predetermined course, the home appliance control unit 211 notifies the operation history management unit 214 of operation information indicating that operation in the predetermined course has finished.

The operation history management unit 214 acquires operation information of the home appliance control unit 211 by receiving a notification from the home appliance control unit 211. Note that the operation history management unit 214 may acquire operation information of the home appliance control unit 211 by periodically referring to the operation information of the home appliance control unit 211. The operation history management unit 214 accumulates the acquired operation information in the operation history storage unit 215 together with time information.

The operation history storage unit 215 stores operation history information in which operation information of the washing machine 112 is associated with time information.

The home appliance control unit 211 is connected to the network 200 via the communication unit 210, and transmits operation information of the washing machine 112 to the server 100 together with identification information unique to the washing machine 112. The operating information represents a current operation state of the washing machine 112. The operation information indicates, for example, information indicating a course reserved by the washing machine 112, information indicating a process name currently performed by the washing machine 112, such as a washing process, information indicating remaining time of the process currently performed by the washing machine 112, and the like. Further, the operation information may include information indicating a maintenance function implemented by the washing machine 112. The communication unit 210 transmits the operation information and the identification information to the server 100.

The communication unit 201 of the server 100 receives the operation information and the identification information transmitted by the washing machine 112.

The apparatus information storage unit 203 stores identification information of the washing machine 112 and identification information of the terminal 120 in association with each other. The identification information of the washing machine 112 and the identification information of the terminal 120 are registered in advance. For example, the user may input the identification information of the washing machine 112 and the identification information of the terminal 120 using the terminal 120.

The external terminal communication control unit 202 refers to the apparatus information storage unit 203 and determines whether or not the identification information of the terminal 120 corresponding to the identification information of the washing machine 112 received by the communication unit 201 exists. In a case where the identification information of the terminal 120 exists, the external terminal communication control unit 202 transmits the operation information of the washing machine 112 to the terminal 120 via the communication unit 201. Further, in the first embodiment, the server 100 notifies operation information and the like of the washing machine 112 to the terminal 120. However, the terminal 120 may transmit a control request for operation start and the like to the washing machine 112.

Here, information stored in the operation history storage unit 215 will be described.

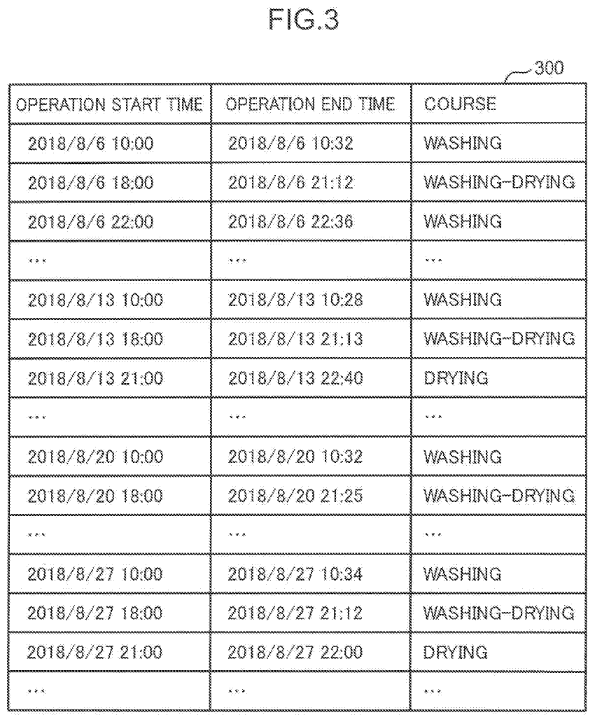

FIG. 3 is a diagram showing an example of operation history information of the washing machine stored in the operation history storage unit shown in FIG. 2.

For example, the operation history storage unit 215 stores an operation history table 300 shown in FIG. 3. The operation history table 300 is operation history information relating to operation of the washing machine 112, in which operation information indicating a course performed by the washing machine 112 is associated with time information indicating an operation start time and an operation end time. In the first embodiment, the operation history table 300 includes only a course, an operation start time, and an operation end time. However, the operation history table 300 may also include information indicating a current control parameter or sensor information for the washing machine 112. The operation history table 300 may include only an operation start time and an operation end time.

The operation start time is represented by year, month, day, and time when operation of the washing machine 112 is started, and the operation end time is represented by year, month, day, and time when operation of the washing machine 112 is finished. Further, the course indicates a process performed when the washing machine 112 is in operation, and represents, for example, any of “washing”, “washing-drying” and “drying”.

Again, with reference to FIG. 2, a configuration regarding processing of suggesting implementation of a function installed in the washing machine 112 which is an example of a home appliance will be described. The washing machine 112 includes an idle time period estimation unit 216 and a function implementation suggestion unit 218 in order to suggest a function desired by a manufacturer to be implemented by the user.

The idle time period estimation unit 216 acquires operation history information indicating a history of an operation state of the washing machine 112. The idle time period estimation unit 216 estimates an idle time period (unused time period) in which the washing machine 112 is not used, using the operation history information. The idle time period estimation unit 216 acquires operation history accumulated in the operation history storage unit 215 at a timing at which the user operates the washing machine 112, estimates an idle time period after the present time based on the operation state of the washing machine 112 up to the present. The idle time period estimation unit 216 estimates an idle time period after the current time based on an operation pattern of the washing machine 112 in a predetermined period in the past.

Further, the operation history management unit 214 may count the number of times the user has stopped a function performed immediately after operation of the washing machine 112 is finished, and store the number in the operation history storage unit 215. Then, when the number of times of stoppage stored in the operation history storage unit 215 is equal to or greater than a threshold value, the idle time period estimation unit 216 may exclude, from the idle time period, a predetermined time period immediately after the operation of the washing machine 112 is finished.

Note that an estimation method of an idle time period will be described later.

The function information storage unit 217 stores in advance a function information table indicating a function installed in the washing machine 112.

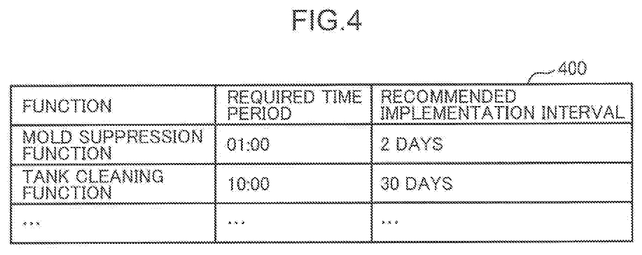

FIG. 4 is a diagram showing an example of function information of the washing machine stored in the function information storage unit shown in FIG. 2.

The functions include a function of performing maintenance of the washing machine 112, and are set by a manufacturer so as to be desirably implemented by the user. A function information table 400 shown in FIG. 4 includes a name of a function installed in the washing machine 112, a required time period for implementing the function, and a recommended implementation interval. The functions of the washing machine 112 include, for example, a mold suppression function of suppressing generation of mold by releasing fine ions into a washing tank, and a tank cleaning function of cleaning the inside of the washing tank. A required time period of the mold suppression function is, for example, one hour, and a required time period of the tank cleaning function is, for example, ten hours. Each function has a recommended implementation interval set by a manufacturer. The recommended implementation interval of the mold suppression function is, for example, two days, and the recommended implementation interval of the tank cleaning function is, for example, 30 days.

The function implementation suggestion unit 218 determines a function to be implemented in an idle time period in the future based on an idle time period and a time period required from the start to the end of the function. The function implementation suggestion unit 218 acquires an estimation result of the idle time period estimation unit 216, refers to a required time period of a function from the function information table 400 held in advance in the function information storage unit 217, and determines a function that can be implemented in an idle time period.

Further, the function implementation suggestion unit 218 may determine a function to be implemented, by referring to a recommended implementation interval in the function information table 400 and using an elapsed time period from a previous implementation. The function implementation suggestion unit 218 acquires a recommended implementation interval from implementation of a function to a next implementation of the function. The function implementation suggestion unit 218 extracts a function that can be implemented in an idle time period, and determines the extracted function as a function to be implemented in an idle time period in a case where a period from a previous implementation of the extracted function to the present exceeds the recommended implementation interval. By considering a recommended implementation interval of a function, a maintenance function to be performed at an appropriate timing can be suggested at a moderate frequency without bothering the user, and the maintenance function can be implemented reliably.

Furthermore, in a case where a plurality of idle time periods are estimated, the function implementation suggestion unit 218 determines a function to be implemented in order from an idle time period closer to the current time among a plurality of idle time periods. The function implementation suggestion unit 218 determines a function to be implemented in an idle time period closest to the current time among a plurality of idle time periods.

The output unit 212 is, for example, a liquid crystal display device, and displays various pieces of information. The output unit 212 outputs information for promoting implementation of a determined function in an idle time period.

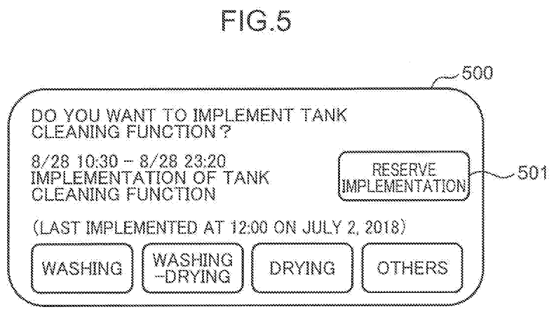

FIG. 5 is a diagram showing an example of information output by the output unit shown in FIG. 2.

The output unit 212 displays a suggestion screen 500 for prompting the user to implement a function determined by the function implementation suggestion unit 218 in an idle time period estimated by the idle time period estimation unit 216. On the suggestion screen 500 shown in FIG. 5, information prompting implementation of the tank cleaning function in an idle time period is displayed. Further, on the suggestion screen 500, an estimated idle time period is displayed. In FIG. 5, the idle time period is from 10:30 to 23:20 on August 28.

Further, the suggestion screen 500 may include a reservation button 501 for automatically implementing a suggested function. The input unit 213 may receive input by the user as to whether or not to implement a determined function in an idle time period. This can increase the possibility that the determined function is implemented by the user. In a case where the washing machine 112 is caused to implement a determined function in an idle time period, the user presses (touches) the reservation button 501. In a case where input by the user to implement the determined function in the idle time period is received, the home appliance control unit 211 implements the determined function in the idle time period. At this time, in a case where the idle time period is longer than a required time period of the determined function, the home appliance control unit 211 may implement the function determined from the start time of the idle time period.

Further, the communication unit 210 may notify the user of the fact that the implementation of the determined function is based on output information within a predetermined time period before the time to start the implementation of the determined function or within a predetermined time after the time to start the implementation of the determined function. In a case where, after an automatic implementation reservation is received by the input unit 213, it is close to or reaches the time for implementing a function for which the reservation is received, the communication unit 210 may transmit, via the server 100, a notification of the start of function implementation to the terminal 120 that cooperates with the washing machine 112.

Further, a predetermined time period before the time for starting the implementation of the determined function, the communication unit 210 may notify the user of information prompting the user to implement preliminary work before implementing the determined function. For example, in order to implement the tank cleaning function, which is an example of a function installed in the washing machine 112, it is necessary to have the user put a dedicated detergent in the washing machine 112. As described above, assuming that there is a function that requires preliminary work to be implemented, the communication unit 210 may notify the terminal 120 of information prompting putting of a detergent after the implementation is reserved. The washing machine 112 may detect putting of the detergent by the use to automatically implement the tank cleaning function.

Note that, in the first embodiment, the output unit 212 of the washing machine 112 displays the suggestion screen 500 shown in FIG. 5. However, the configuration may be such that the suggestion screen 500 shown in FIG. 5 is displayed on a display unit of the terminal 120 cooperating with the washing machine 112, and the input unit of the terminal 120 receives an implementation reservation.

Furthermore, as shown in FIG. 5, the suggestion screen 500 may include date and time when the determined function is performed previously.

Further, in the first embodiment, the output unit 212 displays the information prompting the implementation of the determined function in the idle time period, and displays the reservation button 501 that receives input by the user as to whether or not to implement the determined function in the idle time period. However, the present disclosure is not particularly limited to the above, and the configuration may be such that the output unit 212 displays only information prompting the implementation of the determined function in the idle time period.

Subsequently, information output processing of the washing machine 112 that outputs information prompting the implementation of an installed function will be described.

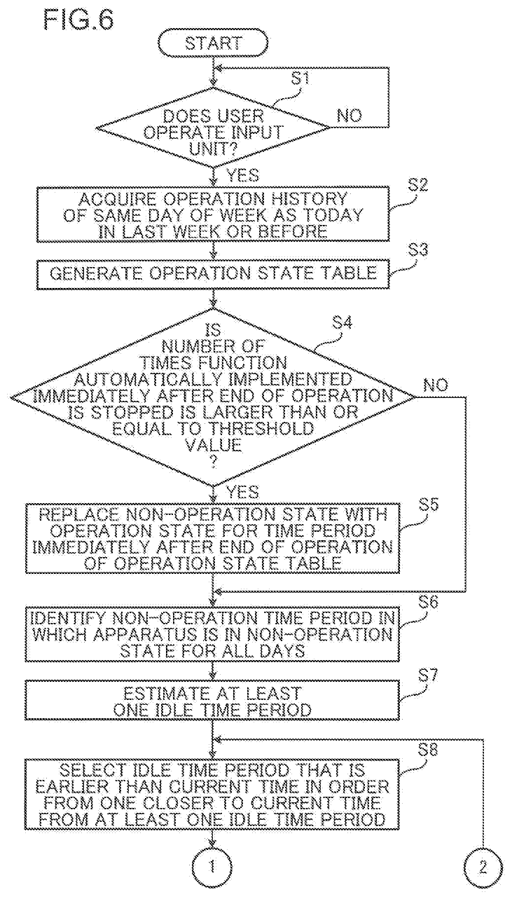

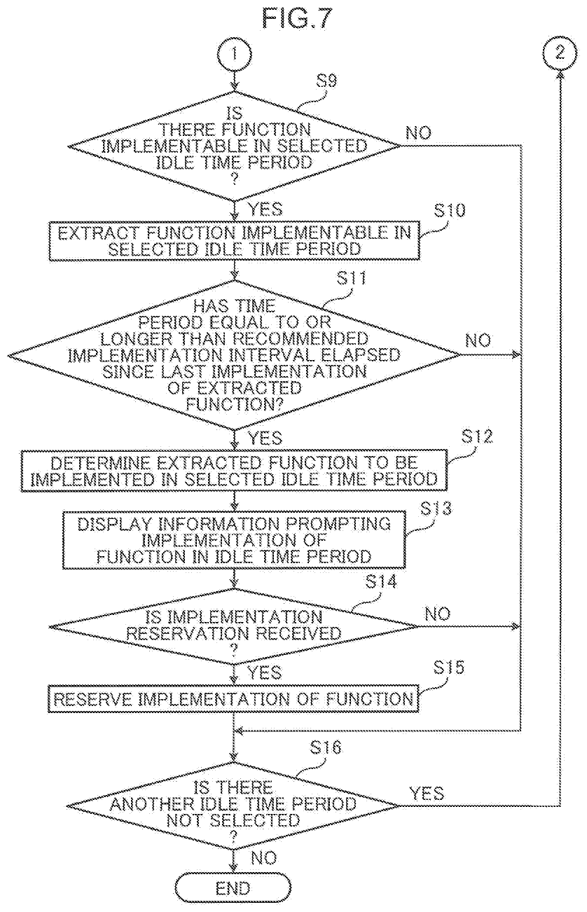

FIG. 6 is a first flowchart showing an example of the information output processing by the washing machine in the first embodiment, and FIG. 7 is a second flowchart showing an example of the information output processing by the washing machine in the first embodiment.

First, the home appliance control unit 211 determines whether or not the user has operated the input unit 213 in order to use the washing machine 112 (Step S1). For example, when the power is turned on by the user, the home appliance control unit 211 determines that the user operates the input unit 213. Further, when the input unit 213 is a touch panel, the home appliance control unit 211 may determine that the user has operated the input unit 213 when, for example, a touch on the touch panel by the user is detected. The home appliance control unit 211 notifies the idle time period estimation unit 216 that the input unit 213 has been operated by the user. Here, in a case where it is determined that the user has not operated the input unit 213 (NO in Step S1), the determination in Step S1 is repeated.

On the other hand, in a case where it is determined that the user has operated the input unit 213 (YES in Step S1), the idle time period estimation unit 216 acquires from the operation history storage unit 215 an operation history of the same day of the week as today in or before the last week (Step S2). Note that, the idle time period estimation unit 216 acquires the operation history of the same day as today in or before the last week. However, the configuration may be such that, in a case where an amount of data is large, the operation history of the same day as the previous year is acquired or the operation history of predetermined days before is acquired. Further, the idle time period estimation unit 216 may acquire all operation histories in the past, or may acquire the operation history up to a predetermined period, such as three months ago. The idle time period estimation unit 216 may expand or contract a range of the operation history to be acquired in accordance with data processing performance of the washing machine 112.

Next, the idle time period estimation unit 216 divides 24 hours of each day of the acquired operation history into predetermined time periods, and generates an operation state table indicating any of an operation state, in which the washing machine 112 is in operation, and a non-operation state, in which the washing machine 112 is not in operation, in each of the divided predetermined time periods (Step S3). The predetermined time period is, for example, 30 minutes.

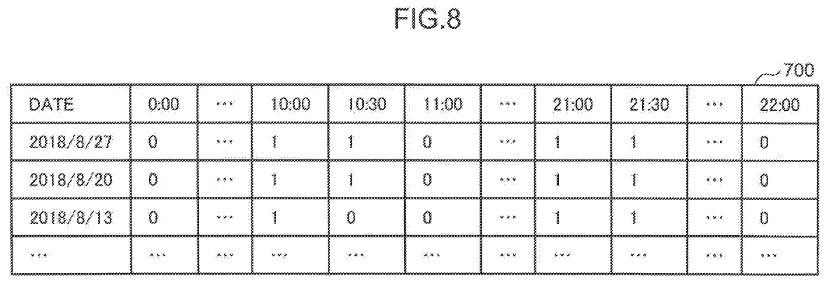

FIG. 8 is a diagram showing an example of the operation state table in the first embodiment.

In an operation state table 700, a day is divided at intervals of 30 minutes, which is a predetermined time period based on the operation history table 300 shown in FIG. 3, and whether or not the washing machine 112 is operated in each of the divided time periods is registered. In FIG. 8, “1” indicates the operation state, and “0” indicates the non-operation state. Note that in the first embodiment, whether or not the washing machine 112 is operated every 30 minutes is shown. However, whether or not the washing machine 112 is operated every optional time period, such as every minute or every hour, may be shown. Note that, the operation state and the non-operation state, which are represented by “1” and “0”, may be represented by other symbols.

Next, the idle time period estimation unit 216 determines whether or not the number of times of the function automatically implemented immediately after the end of the operation of the washing machine 112 is stopped by the user is equal to or greater than a threshold value (Step S4). The idle time period estimation unit 216 considers whether or not the user tends to manually stop the function that is automatically implemented immediately after the operation of the washing machine 112 is finished.

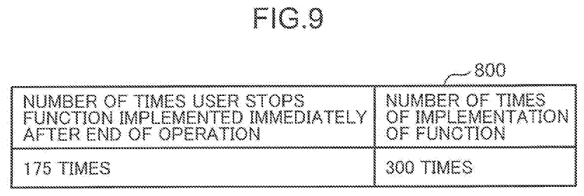

FIG. 9 is a diagram showing an example of a table in which the number of times the user stops the function automatically implemented immediately after the end of operation and the number of times the function is implemented are associated in the first embodiment. The operation history management unit 214 counts the number of times the user has stopped a function implemented immediately after operation of the washing machine 112 is finished, and stores the number in the operation history storage unit 215. The operation history storage unit 215 stores a table 800 in which the number of times the user stops the function automatically implemented immediately after the end of the operation of the washing machine 112 is associated with the number of times of the function is implemented.

Note that the operation history storage unit 215 stores, in the form of a table, the number of times the user has stopped the function implemented immediately after the operation of the washing machine 112 is finished. However, in a case where the operation history includes the operation history by the user, the implemented function and the user's stopping operation may be stored in association with each other as an operation history, and the idle time period estimation unit 216 can also derive the number of times the function is stopped from the operation history. Therefore, the operation history storage unit 215 may store information in a format other than that of the illustrated table 800. In the table 800 shown in FIG. 9, among the number of times of implementation of the function immediately after the end of 300 times of operation, the number of times the function performed immediately after the end of the operation is stopped by the user is 175.

The threshold value is, for example, half the number of times the function is automatically implemented. The idle time period estimation unit 216 determines whether or not the number of times the function automatically implemented immediately after the end of the operation of the washing machine 112 is stopped by the user is a half or more of the number of times the function is automatically implemented. In the table 800 shown in FIG. 9, the number of times the user stops the function implemented immediately after the end of the operation is 175 and the number of times the function is implemented immediately after the end of the operation is 300. Accordingly, the number of times the function implemented immediately after the end of the operation is stopped by the user is equal to or more than half the number of times the function is implemented immediately after the end of operation. For this reason, in the example of the table 800 shown in FIG. 9, the idle time period estimation unit 216 determines that the number of times the function automatically implemented immediately after the end of the operation of the washing machine 112 is stopped by the user is equal to or more than the threshold value.

Here, in a case where the number of times the user stops the function automatically implemented immediately after the end of the operation of the washing machine 112 is smaller than the threshold value (NO in Step S4), the processing proceeds to Step S6.

On the other hand, in a case where the number of times the user stops the function automatically implemented immediately after the end of the operation of washing machine 112 is equal to or more than the threshold value (YES in Step S4), the idle time period estimation unit 216 replaces the non-operation state with the operation state for a time period immediately after the end of the operation of the operation state table 700 in order to exclude the time period immediately after the end of the operation from the idle time period (Step S5). For example, in the operation state table 700 shown in FIG. 8, in a case where the operation of the washing machine 112 is finished in a time period of 30 minutes from 10:30 on Aug. 27, 2018, the idle time period estimation unit 216 replaces the non-operation state “0” with the operation state “1” for a time period of 30 minutes from 11:00 which is a time period immediately after the end of the operation.

By this replacement processing, an idle time period can be estimated in consideration of the fact that the user tends to manually stop the function to be implemented immediately after the end of the operation. Note that in the first embodiment, the threshold value is half the number of times of implementation of the function. However, the present disclosure is not particularly limited to this, and the threshold value may be an optional number of times or another threshold value.

Next, the idle time period estimation unit 216 identifies a non-operation time period in which the apparatus is in the non-operation state for all days using the operation state table 700 (Step S6). At this time, the idle time period estimation unit 216 calculates the OR (logical sum) of each column of the operation state table 700. That is, since the operation state is “1” and the non-operation state is “0”, a non-operation time period in which the apparatus is in the non-operation state for all days is identified by calculating the logical sum of each time period of all days.

Note that, in the first embodiment, the idle time period estimation unit 216 identifies a non-operation time period in which the apparatus is in the non-operation state for all days. However, the present disclosure is not particularly limited to the above, and the idle time period estimation unit 216 may identify a non-operation time period in which the apparatus is in the non-operation state for at least one of all days. In this case, the idle time period estimation unit 216 sets the operation state to “0”, the non-operation state to “1”, and calculates the AND (logical product) of each time period of all the days, so as to identify a non-operation time period in which the apparatus is in the non-operation state for at least one of all days. Further, the idle time period estimation unit 216 may identify a time period in which the number of times of the apparatus is in the operation state is equal to or less than a predetermined number of times as a non-operation time period among all days.

Next, the idle time period estimation unit 216 estimates one or more continuous non-operation time periods as at least one idle time period (Step S7). The idle time period estimation unit 216 may store a start time of the idle time period, an end time of the idle time period, and an interval of the idle time period in the memory 21.

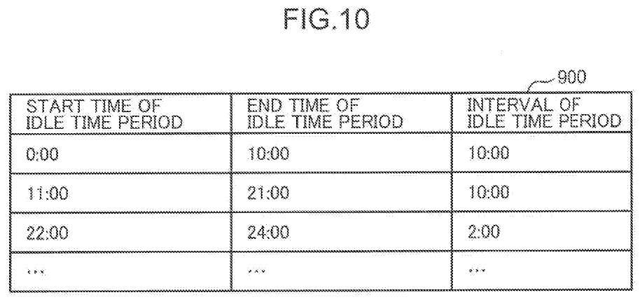

FIG. 10 is a diagram showing an example of the estimated idle time period in the first embodiment. A table 900 includes a start time of the idle time period, an end time of the idle time period, and an interval of the idle time period. The table 900 may include only a start time of the idle time period and an end time of the idle time period, and include only a start time of the idle time period and an interval of the idle time period.

Further, as shown in FIG. 10, the configuration is not limited to a case where only one idle time period is estimated, and there is possibility that a plurality of idle time periods are estimated.

Furthermore, although the table 900 shown in FIG. 10 includes all idle time periods of one day, the present disclosure is not particularly limited to the above, and the table 900 may include an idle time period from the current time among all idle time periods of a day. Further, the idle time period estimation unit 216 may extract, as an estimation result, an idle time period from the current time among all idle time periods on a day in the table 900.

Next, the function implementation suggestion unit 218 selects an idle time period that is earlier than the current time in the order from one closer to the current time from at least one idle time period estimated by the idle time period estimation unit 216 (Step S8). In a case where an idle time period is selected first, the function implementation suggestion unit 218 selects an idle time period that is earlier than the current time and closest to the current time from at least one idle time period estimated by the idle time period estimation unit 216.

Next, the function implementation suggestion unit 218 refers to the function information table 400 of the function information storage unit 217, and determines whether or not there is a function implementable in the selected idle time period (Step S9). As shown in FIG. 4, the function has a required time. If the function information table 400 has a function whose required time is shorter than an interval of the selected idle time period, the function implementation suggestion unit 218 determines that there is a function implementable in the selected idle time period. On the other hand, if the function information table 400 does not have a function whose required time is shorter than an interval of the selected idle time period, the function implementation suggestion unit 218 determines that there is no function implementable in the selected idle time period.

Here, in a case where it is determined that there is no function implementable in the selected idle time period (NO in Step S9), the processing proceeds to Step S16.

On the other hand, in a case where it is determined that there is a function implementable in the selected idle time period (YES in Step S9), the function implementation suggestion unit 218 extracts the function implementable in the selected idle time period from the function information table 400 (Step S10).

Note that in a case where there are a plurality of functions that can be implemented in the selected idle time period, the function implementation suggestion unit 218 may extract a function with a longest required time period among the plurality of functions. Further, in a case where there are a plurality of functions that can be implemented in the selected idle time period, and the total of required time periods of the plurality of functions is equal to or less than an interval of the selected idle time period, the function implementation suggestion unit 218 may extract a plurality of functions.

Next, the function implementation suggestion unit 218 determines whether or not a time period equal to or longer than a recommended implementation interval has elapsed since the last implementation of the extracted function (Step S11). The function implementation suggestion unit 218 can identify date and time when the extracted function is last implemented by referring to the operation history storage unit 215. Here, in a case where it is determined that a time period equal to or longer than the recommended implementation interval has not elapsed since the last implementation of the extracted function (NO in Step S11), the processing proceeds to Step S16.

On the other hand, in a case where it is determined that a time period equal to or longer than the recommended implementation interval has elapsed since the last implementation of the extracted function (YES in Step S11), the function implementation suggestion unit 218 determines the extracted function as the function to be implemented in the selected idle time period (Step S12).

Next, the output unit 212 displays information prompting the user to implement the determined function in the selected idle time period (Step S13). Here, the output unit 212 displays a reservation button for automatically implementing the determined function together with information prompting the implementation of the determined function in the selected idle time period. The input unit 213 receives input by the user as to whether or not to automatically implement the determined function.

Next, the home appliance control unit 211 determines whether or not an implementation reservation of the determined function is received by the input unit 213 (Step S14). Here, in a case where it is determined that the implementation reservation of the determined function is not received by the input unit 213 (NO in Step S14), the processing proceeds to Step S16.

On the other hand, in a case where it is determined that the implementation reservation of the determined function is received by the input unit 213 (YES in Step S14), the home appliance control unit 211 reserves the implementation of the determined function (Step S15). At this time, the home appliance control unit 211 sets a start time of an idle time period to a time at which the implementation of the determined function starts. Further, the home appliance control unit 211 may receive input by the user regarding the time at which the implementation of the determined function starts among idle time periods.

Next, the function implementation suggestion unit 218 determines whether or not there is another idle time period not selected among at least one idle time period (Step S16).

Here, in a case where it is determined that there is another idle time period that has not been selected (YES in Step S16), the processing returns to Step S8, and the function implementation suggestion unit 218 selects an idle time period that is earlier than the current time and closer to the current time next to the previously selected idle time period among at least one idle time period estimated by the idle time period estimation unit 216.

On the other hand, in a case where it is determined that there is no other idle time period that has not been selected (NO in Step S16), the information output processing ends.

Note that the washing machine 112 includes the operation history storage unit 215 in the first embodiment. However, in a case where a large amount of past operation history is used, the server 100 may include the operation history storage unit 215, and the idle time period estimation unit 216 of the washing machine 112 may acquire the operation history from the server 100 to estimate an idle time period.

Further, in a case where the function automatically implemented immediately after the end of the operation of the washing machine 112 is stopped by the user, the function implementation suggestion unit 218 may place priority on determining the function stopped by the user as the function to be implemented in an idle time period in the future.

Further, the server 100 may include the idle time period estimation unit 216, and the function implementation suggestion unit 218 of the washing machine 112 may use an idle time period acquired from the server 100.

By the above processing, in the first embodiment, an idle time period in which the washing machine 112 is not used is estimated from an operation history of the washing machine 112, a function to be implemented in the future in the estimated idle time period is determined, and information that prompts the implementation of the determined function in the idle time period is output. Therefore, it is possible to promote the implementation of a function installed in the washing machine 112 in the idle time period in which the washing machine 112 is not used.

Further, an idle time period in which an apparatus is not used is estimated using operation history information indicating a history of an operation state of the apparatus, a function to be implemented in an idle time period in the future is determined based on the idle time period and a time period required from the start to the end of the function, and information prompting the implementation of the determined function in the idle time period is output. Therefore, it is possible to prompt the implementation of the function installed in the apparatus in the idle time period in which the apparatus is not used without having the user input a usage schedule of the apparatus, and to increase the frequency of implementation of the function installed in the apparatus.

### Second Embodiment

In the first embodiment described above, an example in which the server 100 and the washing machine 112 are connected via the network 200 is described. However, an apparatus other than a washing machine having an input unit may be connected to the server 100 via the network 200. In a second embodiment, an example in which an air conditioner is connected to the server 100 in place of the washing machine will be described.

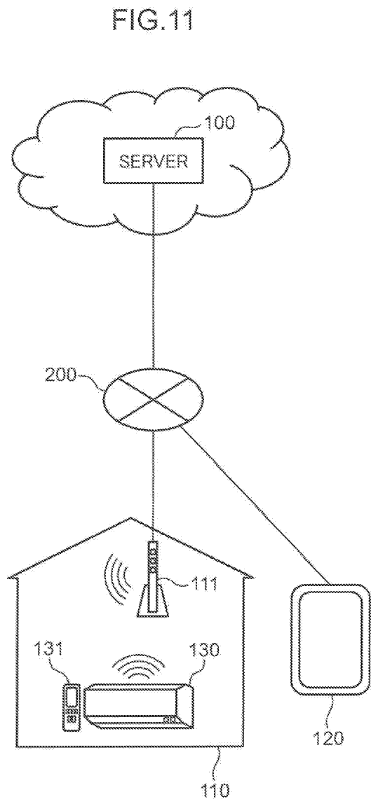

FIG. 11 is a diagram showing an example of a configuration of the home appliance control system according to the second embodiment of the present disclosure. The home appliance control system illustrated in FIG. 11 includes the server 100, the terminal 120, the broadband router 111, and the air conditioner 130. Note that the server 100, the home environment 110, the broadband router 111, the network 200, and the terminal 120 have the same configurations as those of the first embodiment of the present disclosure.

The air conditioner 130 is installed in the home environment 110. The air conditioner 130 is wirelessly connected to the broadband router 111, and is communicably connected to the server 100 via the network 200.

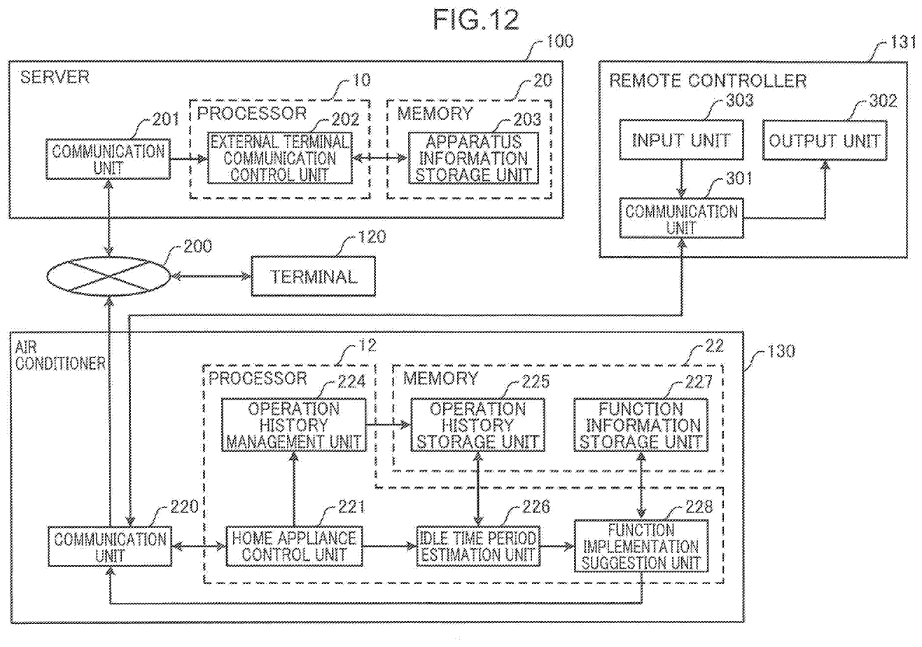

FIG. 12 is a block diagram showing an example of configurations of the server and the air conditioner shown in FIG. 11. In FIG. 12, in order to simplify the illustration and description, only the configurations of the server 100, the air conditioner 130, and a remote controller 131 are illustrated, the broadband router 111 is not shown, the air conditioner 130 is connected to the server 100, and the controller 131 is connected to the air conditioner 130. The air conditioner 130 performs wireless communication with the remote controller 131 by a short distance wireless communication standard, such as, for example, Bluetooth (registered trademark).

Note that, in the second embodiment, the same configurations as those of the first embodiment are denoted by the same reference numerals and will be omitted from the description.

The remote controller 131 includes a communication unit 301, an output unit 302, and an input unit 303.

The input unit 303 is, for example, a touch panel, and receives an input operation by the user. The input unit 303 receives, for example, input of power on/off, selection of a course of any of “cooling”, “heating”, and “dehumidification”, and input of temperature setting and reservation time.

The output unit 302 is, for example, a liquid crystal display device, and displays various pieces of information. The output unit 302 displays current setting content of the air conditioner 130.

The communication unit 301 transmits, to the air conditioner 130, a control request for start of operation and the like received by the input unit 303.

Further, the communication unit 301 receives information prompting the implementation of a determined function in an idle time period transmitted by the air conditioner 130. The output unit 302 outputs information prompting the implementation of the determined function in an idle time period.

The air conditioner 130 includes a processor 12, a memory 22, and a communication unit 220. The processor 12 includes a home appliance control unit 221, an operation history management unit 224, an idle time period estimation unit 226, and a function implementation suggestion unit 228. The memory 22 includes an operation history storage unit 225 and a function information storage unit 227.

The communication unit 220 transmits the operation information and the identification information to the server 100. The communication unit 220 also receives a control request transmitted by the remote controller 131. Further, the communication unit 220 transmits information prompting the implementation of a determined function in an idle time period to the remote controller 131.

The home appliance control unit 221 controls the air conditioner 130 corresponding to the control request received by the communication unit 220.

The operation history management unit 224 acquires operation information of the home appliance control unit 221 by receiving a notification from the home appliance control unit 221. Note that the operation history management unit 224 may acquire operation information of the home appliance control unit 221 by periodically referring to the operation information of the home appliance control unit 221. The operation history management unit 224 accumulates the acquired operation information in the operation history storage unit 225 together with time information. The operation history storage unit 225 stores operation history information in which the operation information of the air conditioner 130 is associated with the time information.

The operation information represents a current operation state of the air conditioner 130. The operation information includes, for example, information indicating a course in which the air conditioner 130, such as cooling, is operated, information indicating a maintenance function implemented by the air conditioner 130, and the like.

Here, information stored in the operation history storage unit 225 will be described.

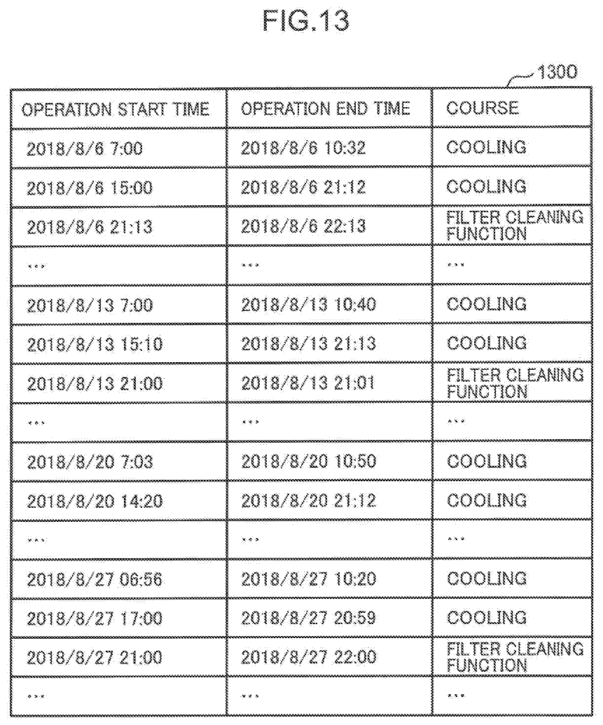

FIG. 13 is a diagram showing an example of the operation history information of the air conditioner stored in the operation history storage unit shown in FIG. 12.

For example, the operation history storage unit 225 stores an operation history table 1300 shown in FIG. 13. The operation history table 1300 is operation history information relating to operation of the air conditioner 130, in which operation information indicating a course performed by the air conditioner 130 is associated with time information indicating an operation start time and an operation end time. In the second embodiment, the operation history table 1300 includes only a course, an operation start time, and an operation end time. However, the operation history table 1300 may also include information indicating a current control parameter or sensor information for the air conditioner 130. Further, the configuration may be such that the operation history table 1300 includes only an operation start time and an operation end time.

The operation start time is represented by year, month, day, and time when operation of the air conditioner 130 is started, and the operation end time is represented by year, month, day, and time when operation of the air conditioner 130 is finished. Further, the course indicates operation content performed when the air conditioner 130 is in operation, and represents, for example, any of “cooling”, “heating”, and “dehumidification”.

The idle time period estimation unit 226 acquires operation history information indicating a history of an operation state of the air conditioner 130. The idle time period estimation unit 226 estimates an idle time period (unused time period) in which the air conditioner 130 is not used, using the operation history information. Note that the configuration of the idle time period estimation unit 226 is the same as that of the idle time period estimation unit 216 of the first embodiment.

The function information storage unit 227 stores in advance a function information table indicating a function installed in the air conditioner 130.

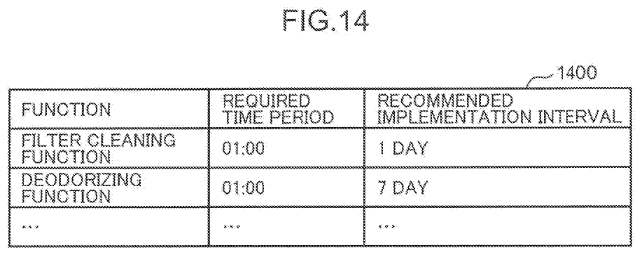

FIG. 14 is a diagram showing an example of function information of the air conditioner stored in the function information storage unit shown in FIG. 12.

The functions include a function of performing maintenance of the air conditioner 130 and are set by a manufacturer to be desirably implemented by the user. A function information table 1400 shown in FIG. 14 includes a name of a function installed in the air conditioner 130, a required time period for implementing the function, and a recommended implementation interval. The functions of the air conditioner 130 include, for example, a filter cleaning function of automatically cleaning a filter, and a deodorizing function for deodorization by discharging fine ions to the inside. A required time period for the filter cleaning function is, for example, one hour, and a required time period for the deodorizing function is, for example, one hour. Each function has a recommended implementation interval set by a manufacturer. The recommended implementation interval of the filter cleaning function is, for example, one day, and the recommended implementation interval of the deodorizing function is, for example, seven days.

The function implementation suggestion unit 228 determines a function to be implemented in an idle time period in the future, based on an idle time period and a time period required from the start to the end of the function. Note that the configuration of function implementation suggestion unit 228 is the same as that of function implementation suggestion unit 218 of the first embodiment.

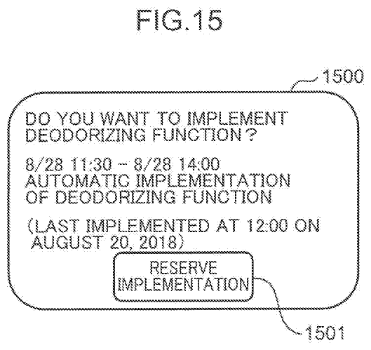

FIG. 15 is a diagram showing an example of information output by the output unit shown in FIG. 12.

The output unit 302 displays a suggestion screen 1500 for prompting the user to implement the function determined by the function implementation suggestion unit 228 in the idle time period estimated by the idle time period estimation unit 226. On the suggestion screen 1500 shown in FIG. 15, information prompting implementation of the deodorizing function in an idle time period is displayed. Further, on the suggestion screen 1500, an estimated idle time period is displayed. In FIG. 15, the idle time period is from 11:30 to 14:00 on August 28.

Further, the suggestion screen 1500 may include a reservation button 1501 for automatically implementing a suggested function. The input unit 303 may receive input by the user as to whether or not to implement a determined function in an idle time period. This can increase the possibility that the determined function is implemented by the user. In a case where the air conditioner 130 is caused to implement a determined function in an idle time period, the user presses (touches) the reservation button 1501. In a case where input by the user to implement the determined function in the idle time period is received, the home appliance control unit 221 implements the determined function in the idle time period. At this time, in a case where the idle time period is longer than a required time period of the determined function, the home appliance control unit 221 may implement the function determined from the start time of the idle time period.

Further, the communication unit 220 may notify the user of the fact that the implementation of the determined function is based on output information within a predetermined time period before the time to start the implementation of the determined function or within a predetermined time after the time to start the implementation of the determined function. In a case where, after an automatic implementation reservation is received by the input unit 303, it is close to or reaches the time for implementing a function for which the reservation is received, the communication unit 220 may transmit, via the server 100, a notification of the start of function implementation to the terminal 120 that cooperates with the air conditioner 130.

Note that, in the second embodiment, the output unit 302 of the remote controller 131 displays the suggestion screen 1500 shown in FIG. 15. However, the suggestion screen 1500 shown in FIG. 15 may be displayed on a display unit of the terminal 120 cooperating with the air conditioner 130, and the input unit of the terminal 120 receives an implementation reservation.

Furthermore, as shown in FIG. 15, the suggestion screen 1500 may include date and time when the determined function is performed previously.

Further, in the second embodiment, the output unit 302 displays the information prompting the implementation of the determined function in the idle time period, and displays the reservation button 1501 that receives input by the user as to whether or not to implement the determined function in the idle time period. However, the present disclosure is not particularly limited to the above, and the output unit 302 may display only information prompting the implementation of the determined function in the idle time period.

Note that, the information output processing of the air conditioner 130 for outputting information prompting the implementation of an installed function in the second embodiment is the same as the information output processing of the washing machine 112 in the first embodiment except that the input unit and the output unit are in the remote controller, and will be omitted from the description.

Further, FIGS. 11 and 12 show the air conditioner 130 as an example of apparatus. However, the present disclosure is not particularly limited to this example, and any apparatus may be employed as long as the apparatus includes an input unit for receiving input, and is equipped with a function that a manufacturer desires be implemented regularly, such as a self-maintenance function. Note that, in the second embodiment, various changes can be made as in the first embodiment.

### Third Embodiment

In the first embodiment described above, an example in which the server 100 and the washing machine 112 are connected via the network 200 is described, and in the second embodiment, an example in which the server 100 and the air conditioner 130 are connected via the network 200 is described. However, there is a case where the user does not use a home appliance in cooperation with the terminal 120. In a third embodiment, an example in which there is no cooperation between the server 100 and the terminal 120 will be described.

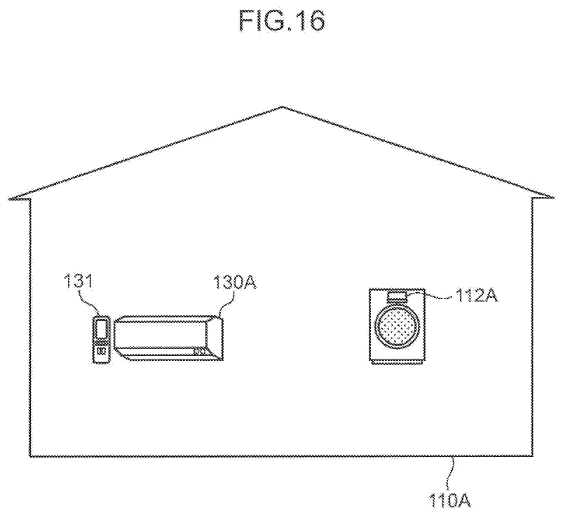

FIG. 16 is a diagram showing an example of a washing machine and an air conditioner installed in a home environment in the third embodiment of the present disclosure. The washing machine 112 and the air conditioner 130 are installed in a home environment 110A. Note that, in the home environment 110A, a local area network may be available or unavailable. Although the home environment 110A is an area in a home of the user, the present disclosure is not particularly limited to this example, and may be an area in a facility or a building of a company.

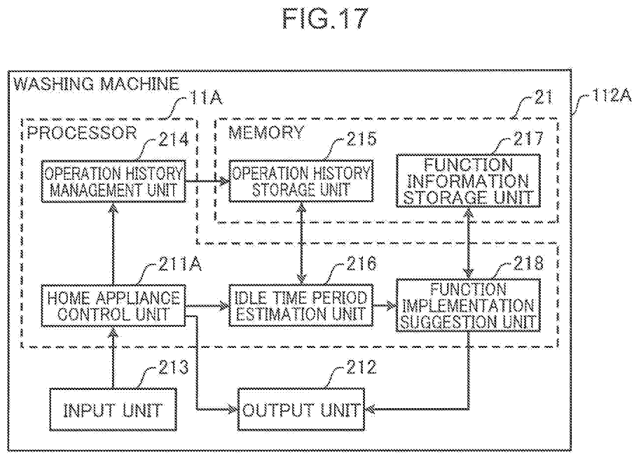

FIG. 17 is a block diagram showing an example of a configuration of the washing machine shown in FIG. 16. Note that, in a washing machine 112A of the third embodiment, the same configuration as that of the first embodiment is denoted by the same reference numeral and will be omitted from the description.

The washing machine 112A includes a processor 11A, the memory 21, the communication unit 210, the output unit 212, and the input unit 213. The processor 11A includes a home appliance control unit 211A, the operation history management unit 214, the idle time period estimation unit 216, and the function implementation suggestion unit 218. The memory 21 includes an operation history storage unit 215 and a function information storage unit 217.

Unlike the first embodiment, the washing machine 112A does not include a communication unit that communicates with a server. For this reason, the home appliance control unit 211A does not have a function of transmitting operation information of the washing machine 112A and identification information of the washing machine 112A to a server.

Note that, the information output processing of the washing machine 112A for outputting information prompting the implementation of an installed function in the third embodiment is the same as the information output processing of the washing machine 112 in the first embodiment, and will be omitted from the description.

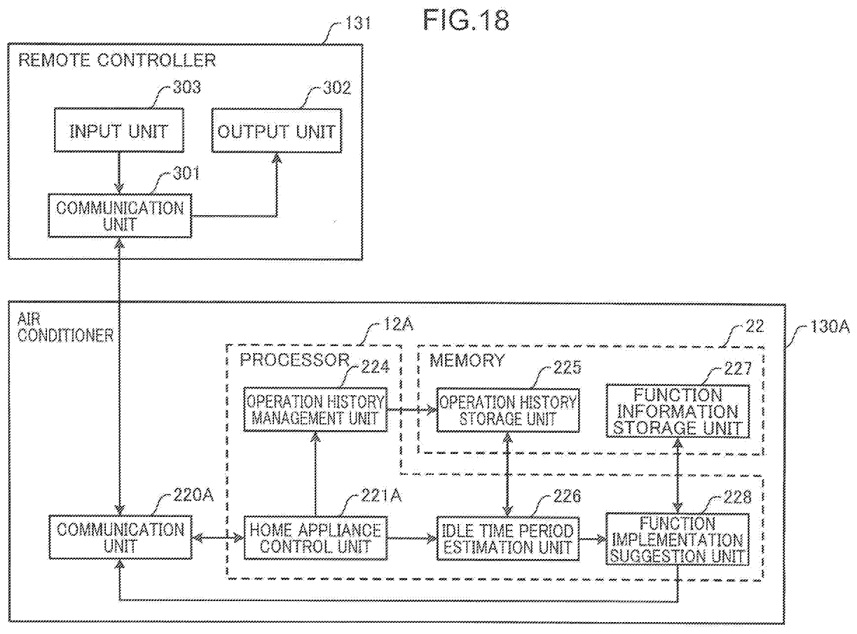

FIG. 18 is a block diagram showing an example of a configuration of the air conditioner shown in FIG. 16. Note that, in the air conditioner 130A and the remote controller 131 of the third embodiment, the same configuration as that of the second embodiment is denoted by the same reference numeral and will be omitted from the description.

The air conditioner 130A includes a processor 12A, the memory 22, and a communication unit 220A. The processor 12A includes a home appliance control unit 221A, the operation history management unit 224, the idle time period estimation unit 226, and the function implementation suggestion unit 228. The memory 22 includes an operation history storage unit 225 and a function information storage unit 227.

Unlike the second embodiment, the communication unit 220A of the air conditioner 130A does not have a function of communicating with a server, and only has a function of communicating with the remote controller 131. For this reason, the home appliance control unit 221A does not have a function of transmitting operation information of the air conditioner 130A and identification information of the air conditioner 130A to a server.

Note that, the information output processing of the air conditioner 130A for outputting information prompting the implementation of an installed function in the third embodiment is the same as the information output processing of the air conditioner 130 in the second embodiment, and will be omitted from the description.

Further, FIGS. 16, 17, and 18 show the washing machine 112A and the air conditioner 130A as an example of apparatus. However, the present disclosure is not particularly limited to this example, and any apparatus may be employed as long as the apparatus includes an input unit for receiving input, and is equipped with a function that a manufacturer desires be implemented regularly, such as a self-maintenance function. Note that, in the third embodiment, various changes can be made as in the first embodiment.

### Fourth Embodiment

In the first embodiment described above, the idle time period estimation unit 216 acquires an operation history of the same day of the week in the past. Acquisition of the operation history is processing for identifying a time period in which the user operates apparatus. In a fourth embodiment, an example will be described in which an apparatus cooperates with a weather information server on a network in order to identify a time period in which the user operates the apparatus with higher accuracy.

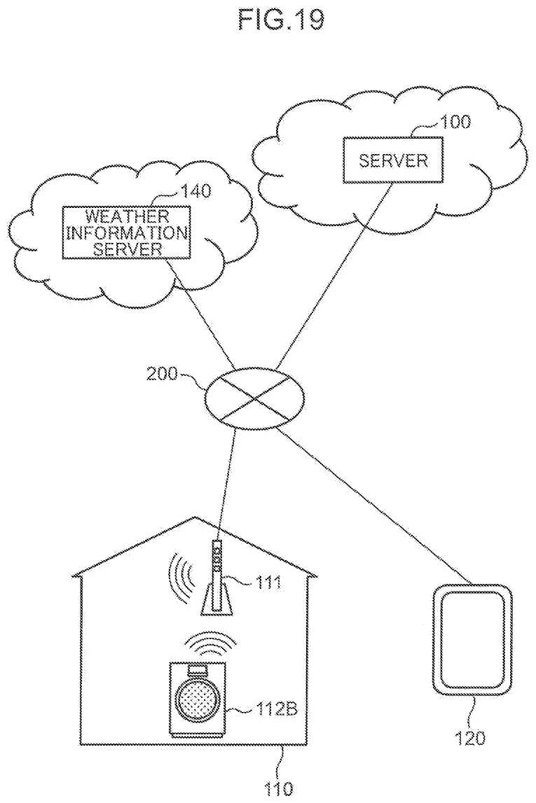

FIG. 19 is a diagram showing an example of a configuration of a home appliance control system according to the fourth embodiment of the present disclosure. The home appliance control system shown in FIG. 19 includes the server 100, the terminal 120, the broadband router 111, a washing machine 112B, and a weather information server 140. Note that the server 100, the home environment 110, the broadband router 111, the network 200, and the terminal 120 have the same configurations as those of the first embodiment of the present disclosure.

The weather information server 140 is communicably connected to the washing machine 112B via the network 200, and provides weather information relating to weather in the past, weather at the present, and/or weather in the future of a spot where the washing machine 112B is installed. The washing machine 112B transmits a request signal for requesting weather information to the weather information server 140. The weather information server 140 identifies a spot where the washing machine 112B is installed based on IP address information included in the request signal transmitted by the washing machine 112B, and transmits weather information of the specified spot to the washing machine 112B.

The washing machine 112B is wirelessly connected to the broadband router 111, and is communicably connected to the server 100 and the weather information server 140 via the network 200.

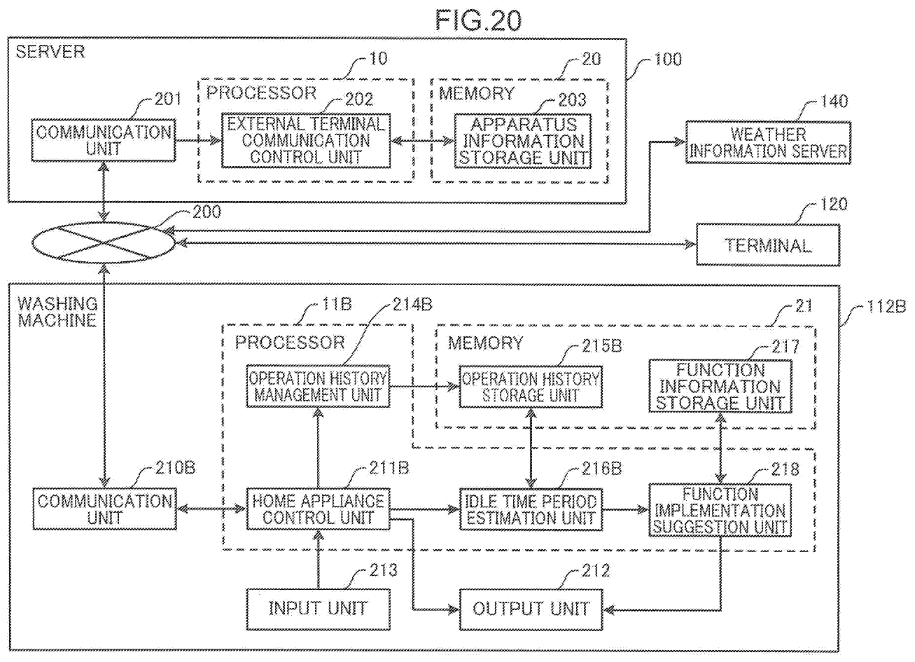

FIG. 20 is a block diagram showing an example of a configuration of the server and the washing machine shown in FIG. 19. Note that in FIG. 20, in order to simplify the illustration and description, only the configurations of the server 100 and the washing machine 112B are illustrated, illustration of the broadband router 111 is omitted, and the washing machine 112B is connected to the server 100 and the weather information server 140.

Note that, in the fourth embodiment, the same configurations as those of the first embodiment are denoted by the same reference numerals and will be omitted from the description.

The washing machine 112B includes a processor 11B, the memory 21, a communication unit 210B, the output unit 212, and the input unit 213. The processor 11B includes a home appliance control unit 211B, an operation history management unit 214B, an idle time period estimation unit 216B, and the function implementation suggestion unit 218. The memory 21 includes an operation history storage unit 215B and the function information storage unit 217.

The communication unit 210B receives weather information relating to at least one of weather in the past, weather at the present, and weather in the future of a spot where the washing machine 112B is installed from the weather information server 140.

The home appliance control unit 211B controls the washing machine 112B corresponding to the input operation. When starting operation of a predetermined course, the home appliance control unit 211B acquires, via the communication unit 210B, weather information relating to weather at the present of a spot where the washing machine 112B is installed. Then, the home appliance control unit 211B notifies the operation history management unit 214B of operation information indicating that the operation of the predetermined course is started and the weather information relating to the weather at the present. Further, when finishing operation in a predetermined course, the home appliance control unit 211B notifies the operation history management unit 214B of operation information indicating that operation in the predetermined course has finished.

Note that, in the present embodiment, when starting the operation in a predetermined course, the home appliance control unit 211B acquires weather information. However, the present disclosure is not particularly limited to the above, and weather information may be acquired when operation in a predetermined course ends. Further, the home appliance control unit 211B may periodically acquire weather information, and may use weather information acquired at a timing closest to a time point at which operation of a predetermined course starts, or weather information acquired at a timing closest to a time point at which operation of a predetermined course ends. Furthermore, the home appliance control unit 211B may acquire weather information in units of time, or may acquire weather information in units of days.

The operation history management unit 214B acquires operation information and weather information of the home appliance control unit 211B by receiving a notification from the home appliance control unit 211B. Note that the operation history management unit 214B may acquire operation information of the home appliance control unit 211B and weather information by periodically referring to the operation information of the home appliance control unit 211B. The operation history management unit 214B accumulates the acquired operation information and weather information in the operation history storage unit 215B together with time information.

The operation history storage unit 215B stores operation information of the washing machine 112B, time information, and weather information by associating with each other. The operation history information includes weather information at the time of operation of the washing machine 112B as well as the operation state.

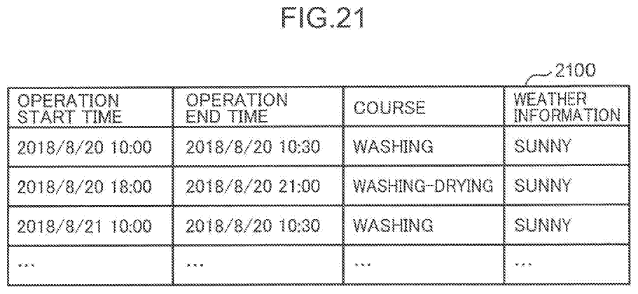

FIG. 21 is a diagram showing an example of an operation history of the washing machine stored in the operation history storage unit shown in FIG. 20. For example, the operation history storage unit 215B stores an operation history table 2100 shown in FIG. 21. The operation history table 2100 includes history information relating to the operation of the washing machine 112B, such as a course performed by the washing machine 112B, an operation start time, an operation end time, and weather information. In the present fourth embodiment, the operation history table 2100 includes only a course, an operation start time, an operation end time, and weather information. However, the operation history table 2100 may also include information indicating a current control parameter or sensor information for the washing machine 112B. Further, the configuration may be such that the operation history table 2100 includes only the operation start time, the operation end time, and the weather information.

The operation start time is represented by year, month, day, and time when operation of the washing machine 112B is started, and the operation end time is represented by year, month, day, and time when operation of the washing machine 112B is finished. Further, the course indicates a process performed when the washing machine 112B is in operation, and represents, for example, any of “washing”, “washing-drying”, and “drying”. Further, the weather information indicates weather at a spot where the washing machine 112B is installed at a time point at which the operation of the washing machine 112B is started or at a time point at which the operation of the washing machine 112B is finished. The weather is, for example, “sunny”, “rainy”, “cloudy”, “snowy”, or the like.

Before acquiring operation history information, the idle time period estimation unit 216B acquires, via the communication unit 210B, weather information relating to weather at or after the current time of a spot where the washing machine 112B is installed. The idle time period estimation unit 216B acquires operation history information including the same weather information as the acquired weather information at or after the current time. The idle time period estimation unit 216B acquires, from the operation history storage unit 215B, an operation history that is of the same day of the week as today in the last week or before and includes the same weather information as the weather information at or after the current time. Then, using the operation history information, the idle time period estimation unit 216B estimates an idle time period (unused time period) in which the washing machine 112B is not used.

Note that the idle time period estimation unit 216B may acquire weather information at or after the current time on a time basis, or may acquire weather information at or after the current time on a daily basis.

Note that, the information output processing of the washing machine 112B for outputting information prompting the implementation of an installed function in the fourth embodiment is different from the information output processing of the washing machine 112 in the first embodiment only in the processing of Step S2 in FIG. 6. Therefore, in the fourth embodiment, only a difference in the processing of Step S2 of FIG. 6 will be described.

In a case where the user is determined to operate the input unit 213 (YES in Step S1), the idle time period estimation unit 216B acquires, via the communication unit 210B, weather information relating to weather at or after the current time of a spot where the washing machine 112B is installed. Next, the idle time period estimation unit 216B acquires, from the operation history storage unit 215B, an operation history that is of the same day of the week as today in the last week or before and includes the same weather information as the weather information at or after the current time.

In the fourth embodiment, a time period in which the user operates the apparatus can be identified with higher accuracy.

Note that, in the fourth embodiment, the weather information is information relating to weather, such as sunny or rainy weather. However, the information is an example, and the weather information may be information relating to an air temperature or humidity.

Further, in the fourth embodiment, the operation history storage unit 215B stores operation history information in which operation information, time information, and weather information are associated. However, the present disclosure is not particularly limited to the above, and the configuration may be such that the operation history storage unit 215B stores operation history information in which operation information, time information, and weather information are associated, and does not store weather information. In a case where the operation history storage unit 215B does not store weather information, the idle time period estimation unit 216B acquires an operation history of the same day of the week as today in the last week or before from the operation history storage unit 215, and then acquires weather information of the date and time corresponding to time information of the acquired operation history. Then, the idle time period estimation unit 216B acquires, from the acquired operation history, an operation history that is of the same day of the week as today in the last week or before and includes the same weather information as the weather information at or after the current time.

Further, FIGS. 19 and 20 show the washing machine 112B as an example of apparatus. However, the present disclosure is not particularly limited to this example, and any apparatus may be employed as long as the apparatus includes an input unit for receiving input, and is equipped with a function that a manufacturer desires be implemented regularly, such as a self-maintenance function. Note that, in the fourth embodiment, various changes can be made as in the first embodiment.

### Fifth Embodiment

In the fifth embodiment, the home appliance control system includes a home appliance controller that controls home appliances installed in the home in the home environment 110 instead of a server. In this manner, the home appliance control system constitutes a server client model in which the washing machine 112 or the air conditioner 130 is a client and the home appliance controller is a server.

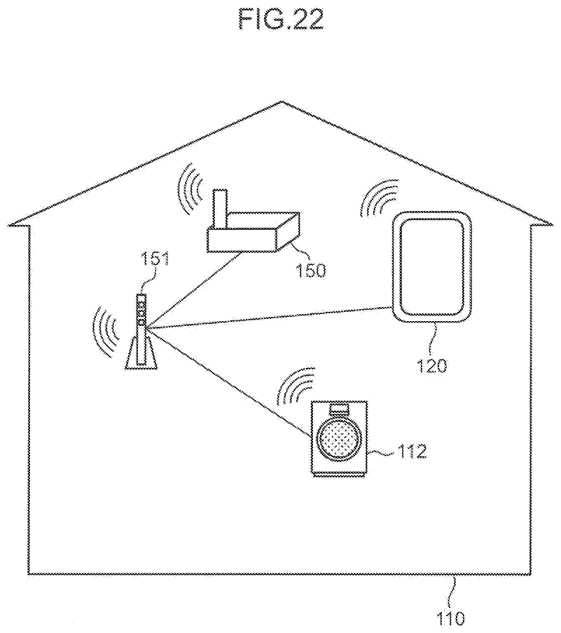

FIG. 22 is a diagram showing an example of the configuration of the home appliance control system according to the fifth embodiment of the present disclosure. The home appliance control system shown in FIG. 22 includes a home appliance controller 150, the terminal 120, a router 151, and the washing machine 112. That is, in the first embodiment, the server 100 connected to the washing machine 112 via the network 200 has a function of communicating with the terminal 120 in cooperation with the washing machine 112, whereas in the fifth embodiment, the home appliance controller 150 includes the function of the server 100, so that processing similar to that of the home appliance control system described in the first embodiment can be performed.

The home appliance controller 150, the router 151, and the washing machine 112 are installed in the home environment 110.

The home appliance controller 150 controls the operation of home appliances installed in the home environment 110. For example, the home appliance controller 150 receives input operation of the washing machine 112 by the user, and transmits a control request corresponding to the received input operation to the washing machine 112.

Note that, as an apparatus to which the fifth embodiment is applied, various apparatuses, such as a home appliance or a business-use appliance, can be used, and, for example, an air conditioner, an air cleaner, a dehumidifier, or the like may be used.

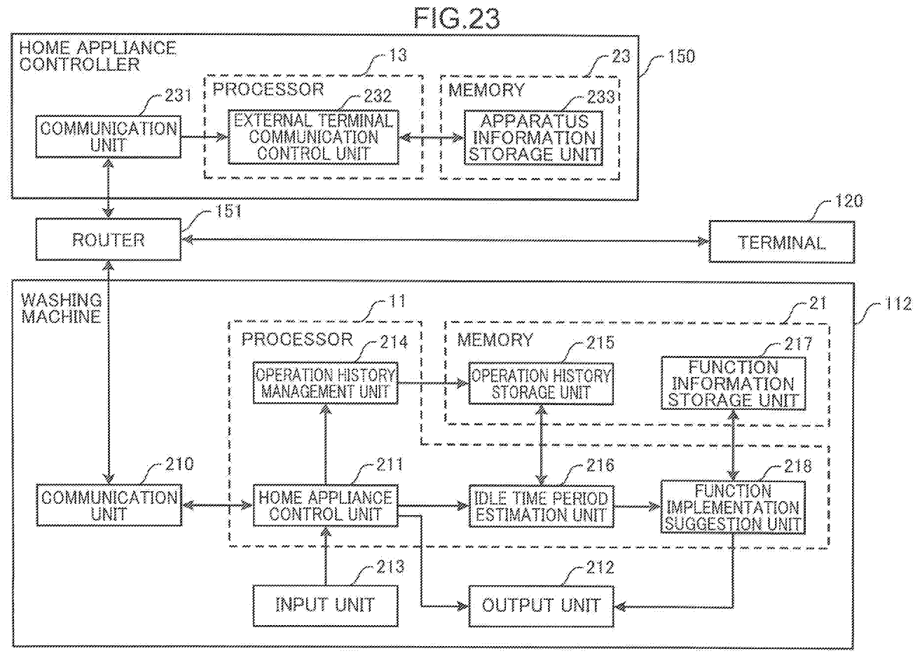

FIG. 23 is a block diagram showing an example of a configuration of the home appliance controller and the washing machine shown in FIG. 22.

The washing machine 112 includes the processor 11, the memory 21, the communication unit 210, the output unit 212, and the input unit 213. The processor 11 includes a home appliance control unit 211, an operation history management unit 214, an idle time period estimation unit 216, and a function implementation suggestion unit 218. The memory 21 includes an operation history storage unit 215 and a function information storage unit 217. Note that, in the fifth embodiment, the same configurations as those of the first embodiment are denoted by the same reference numerals and will be omitted from the description.

The router 151 wirelessly communicates with the home appliance controller 150, the washing machine 112, and the terminal 120. The washing machine 112 is communicably connected to the home appliance controller 150 via the router 151. Further, the terminal 120 is communicably connected to the home appliance controller 150 via the router 151.

The home appliance controller 150 includes a processor 13, a memory 23, and a communication unit 231. The processor 13 includes an external terminal communication control unit 232. The memory 23 includes an apparatus information storage unit 233. The functions of the communication unit 231, the external terminal communication control unit 232, and the apparatus information storage unit 233 are the same as the functions of the communication unit 201, the external terminal communication control unit 202, and the apparatus information storage unit 203 shown in FIG. 2.

Note that, the information output processing of the washing machine 112A for outputting information prompting the implementation of an installed function in the fifth embodiment is the same as the information output processing of the washing machine 112 in the first embodiment, and will be omitted from the description.

Further, the home appliance controller 150 may also include a display unit. In this case, content of a notification from the washing machine 112 may be displayed on a display unit of the home appliance controller 150 instead of the terminal 120. The user may check the content of a notification displayed on the display unit of the home appliance controller 150.

Further, FIGS. 22 and 23 show the washing machine 112 as an example of apparatus. However, the present disclosure is not particularly limited to this example, and any apparatus may be employed as long as the apparatus includes an input unit for receiving input, and is equipped with a function that a manufacturer desires be implemented regularly, such as a self-maintenance function. Note that, in the fifth embodiment, various changes can be made as in the first embodiment.

Although the information output method according to a plurality of modes of the present disclosure has been described so far based on a plurality of the embodiments, the present disclosure is not limited to these embodiments. A mode constructed by combining constituents in different embodiments may be included within the scope of one or more modes of the present disclosure as long as such a mode does not deviate from the spirit of the present disclosure.

Note that, in the above embodiments, each constituent may be configured with dedicated hardware or may be obtained by executing a software program suitable for each constituent. Each constituent may be obtained by a program execution unit, such as a CPU or a processor, reading and executing a software program recorded in a recording medium, such as a hard disk or a semiconductor memory.

Part or all of the functions of the device according to the embodiments of the present disclosure are obtained as large scale integration (LSI), which is typically an integrated circuit. These may be made into one chip individually, or may be made into one chip by including part or all of these. Further, the circuit integration is not limited to LSI, and may be achieved by a dedicated circuit or a general-purpose processor. A field programmable gate array (FPGA) that can be programmed after LSI fabrication, or a reconfigurable processor that can reconfigure connection and setting of circuit cells inside LSI may be used.

Further, part or all of the functions of the device according to the embodiments of the present disclosure may be obtained by a processor, such as a CPU, executing a program.

Further, all the numerals used above are illustrated to specifically describe the present disclosure, and the present disclosure is not limited to the illustrated numerals.

Further, the order in which the steps shown in the flowchart are performed is illustrated to specifically describe the present disclosure, and may be the order other than the above as long as similar effects can be obtained. Further, part of the above steps may be performed simultaneously (in parallel) with other steps.

The information output method, the information output device, and the non-transitory computer-readable recording medium recording an information output program according to the present disclosure can prompt the implementation of a function installed in an apparatus in an unused time period, in which the apparatus is not used, without requiring the user to input a usage schedule of the apparatus, and increase the frequency of the implementation of the function installed in the apparatus, and, therefore, are useful as an information output method, an information output device, and a non-transitory computer-readable recording medium recording an information output program that output information prompting the implementation of a function installed in an apparatus.

This application is based on Japanese Patent application No. 2018-215188 filed in Japan Patent Office on Nov. 16, 2018, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. An information output method of an information output device that outputs information prompting implementation of a function installed in an apparatus, the information output method comprising:
acquiring operation history information indicating a history of an operation state of the apparatus;
estimating, by using the operation history information, an unused time period in which the apparatus is not used;
determining a function to be implemented in the unused time period in future, based on the unused time period and a time period required from start to end of the function; and
outputting information prompting implementation of the determined function in the unused time period.

2. The information output method according to claim 1, further comprising:
counting a number of times a user has stopped a function that is implemented immediately after end of operation of the apparatus; and
excluding, from the unused time period, a predetermined time period immediately after end of operation of the apparatus in a case where the number of times is larger than or equal to a threshold value in estimation of the unused time period.

3. The information output method according to claim 1, further comprising:
receiving input by a user as to whether or not to implement the determined function in the unused time period.

4. The information output method according to claim 3, further comprising:
implementing the determined function in the unused time period in a case where input by the user showing implementation of the determined function in the unused time period is received.

5. The information output method according to claim 3, further comprising:
notifying the user of a fact that implementation of the determined function is implementation based on the output information within a predetermined time period before a time to start implementation of the determined function or within a predetermined time after a time to start implementation of the determined function.

6. The information output method according to claim 3, further comprising:
notifying the user of information prompting implementation of preliminary work performed before implementation of the determined function a predetermined time period before a time to start implementation of the determined function.

7. The information output method according to claim 1, wherein
in the determination of the function, an implementation interval from implementation of the function to next implementation of the function is acquired, a function that is capable of being implemented in the unused time period is extracted, and, in a case where a period from previous implementation of the extracted function to present is longer than the implementation interval, the extracted function is determined to be a function to be implemented in the unused time period.

8. The information output method according to claim 1, wherein
the function includes a function of performing maintenance of the apparatus.

9. The information output method according to claim 1, wherein
In the estimation of the unused time period, the unused time period at or after a current time is estimated based on an operation pattern of the apparatus in a predetermined period in past.

10. The information output method according to claim 1, wherein
the unused time period includes a plurality of unused time periods, and
in the determination of the function, a function to be implemented in an unused time period closest to a current time among the unused time periods is determined.

11. The information output method according to claim 1, wherein
the operation history information includes an operation start time and an operation end time.

12. The information output method according to claim 1, wherein
the operation history information includes weather information at a time point at which the apparatus is operated together with the operation state, the information output method further comprising:
acquiring weather information at or after a current time; and
in acquisition of the operation history information, acquiring the operation history information including weather information that is the same as weather information at or after the acquired current time.

13. An information output device that outputs information prompting implementation of a function installed in an apparatus, the information output device comprising:
an acquisition unit configured to acquire operation history information indicating a history of an operation state of the apparatus;
an estimation unit configured to estimate, by using the operation history information, an unused time period in which the apparatus is not used;
a determination unit configured to determine a function to be implemented in the unused time period in future, based on the unused time period and a time period required from start to end of the function; and
an output unit configured to output information prompting implementation of the determined function in the unused time period.

14. A non-transitory computer-readable recording medium recording an information output program that outputs information prompting implementation of a function installed in an apparatus, the non-transitory computer-readable recording medium recording an information output program that causes a computer to:
acquire operation history information indicating a history of an operation state of the apparatus;
estimate, by using the operation history information an unused time period in which the apparatus is not used;
determine a function to be implemented in the unused time period in future, based on the unused time period and a time period required from start to end of the function; and
output information prompting implementation of the determined function in the unused time period.
